(19) United States
(12) Patent Application Publication
(10) Pub. No.: US 2020/0023374 A1
(43) Pub. Date: Jan. 23, 2020

(54) Solid state drive media destroyer

(71) Applicant: Phiston Technologies, Inc., Miami, FL (US)

(72) Inventors: M. Ali Ebadian, Miami, FL (US); Raul Travieso, Miami, FL (US)

(21) Appl. No.: 16/405,338

(22) Filed: May 7, 2019

Related U.S. Application Data
(63) Continuation-in-part of application No. 16/040,776, filed on Jul. 20, 2018, now abandoned.

(51) Int. Cl. B02C 18/14; B02C 18/24; B02C 25/00

(52) U.S. Cl. CPC B02C 18/142; B02C 25/00; B02C 18/24

(57) ABSTRACT

Disclosed is an apparatus for destroying the operational aspects and electronic media of a Solid State Drive (SSD) yet maintaining the physical shape of the SSD for identification. The apparatus includes a crusher box having counter-rotating rollers that are intermeshed to provide a high speed feed of an SSD wherein teeth formed on the rollers render the electron media non-accessible and impart a distinctive waffle like appearance for ease of identifying destroyed SSD's. A VFD-PID controller is used to vary the speed of an electric motor 50 with the PID having a feedback signal that allows for various target values to be set.

### PRIORITY CLAIM

In accordance with 37 C.F.R. § 1.76, a claim of priority is included in an Application Data Sheet filed concurrently herewith. Accordingly, the present invention claims priority as a continuation-in-part of U.S. patent application Ser. No. 16/040,776, entitled “SOLID STATE DRIVE MEDIA DESTROYER”, filed Jul. 20, 2018. The contents of the above referenced application is incorporated herein by reference in its entirety.

### FIELD OF INVENTION

The invention relates to the field of electronic memory media destruction and in particular to a solid state drive media destroyer leaving a traceable body.

### BACKGROUND OF THE INVENTION

Improperly discarded solid state drives can retain media indefinitely. Electronic media stored on a solid state drive is defined herein as the digital data information stored in memory devices that uses integrated circuit assemblies as memory to store data. It is a common belief that the electronic erasing of a solid state drive (SSD) by demagnetizing permanently destroys all electronic media. However, media deleted from a SSD may be recovered if the electronic erasing was not proper performed, or the equipment used for electronic erasing malfunctions. It has practically a daily occurrence wherein a media organization reports disclosure of confidential media which can easily be caused from an improperly disposed of SSD. Any disclosure of confidential information may cause harm to individuals, businesses and governments.

Confidentiality of electronic remains paramount in modern society. The European Union recently passed the General Media Protection Regulation (GDPR) to reinforce media privacy for citizens and companies. The GDPR includes a process that allows individuals to delete their personal media to prevent harmful hacks. The GDPR also allows for simplified access to an individual's media and notifies individuals if he or she has been hacked. The GDPR spans across Europe but is also included in organizations outside the European Union that process or monitor personal media from the EU or provide goods and services to the EU. It is required for all EU-related organizations to join the GDPR; if they do not they can be fined up to four percent of the company's annual global turnover.

The potential liability and losses from inadvertent disclosures can be devastating to the individual or business. For instance, disclosure of an individual's bank information can wipe out the individual savings and credit rating. While this loss could be financially catastrophic to the individual, such loses are seldom covered by the media unless the individual is a celebrity allowing such crimes to go largely unnoticed.

While there are numerous methods for destroying media, the type of destruction is typically dependent upon the required level of security. In some instances destruction by cutting the SSD into fragments small enough that meaningful media cannot be easily extracted is warranted. Memory media destruction is known in the industry and the Applicant has been awarded patents on various methods for destroying media including U.S. Pat. Nos. 7,975,950; 8,975,950; and 9,776,192.

U.S. Publication (2009/0140086) issued to Thiel discloses the use of a rotatable member 70 secured to a pivot arm 66, and a biasing system 10 connected to the pivot arm 66. A drive gear 36 and idler gear 38 are used with energy from the drive gear 36 approximately evenly split between the idler gear 38 and a second stage gear 47. Thiel relies on spring-loaded counter rotating teeth rollers to puncture Solid State Drives (SSDs). The rotational forces of the rollers slowly push the media through the system while adapting to the media thickness by means of planetary gear-chain, cam linkages, and spring-loaded pistons. The cam motion aspect of the rollers adjusting to the media thickness protects in a punch-press operation.

U.S. Publication (2016/0046040) issued to Dahlheimer relates to plastic strand granulation and more specifically, a method for manufacturing thermoplastic micro-pellets. Dahlheimer apparatus uses dissimilar counter rotating rollers, (a toothed squeezing roller and a plain cylindrical pressure roller), that does not imprint but granulates. Counter rotating rollers are solid cylinders with the toothed roller applying pressure to form plastic strands into granulate cushions for the use of micro-pellet technology.

Fragmental destruction is not necessary in every instance and in many instances the SSD needs to be destroyed but the physical drive maintained in one piece to allow tracking of the destroyed SSD.

What is needed in the industry is a method of destroying SSD's at a high rate of speed while maintaining the body of the SSD to provide physical evidence that SSD has been destroyed.

### SUMMARY OF INVENTION

Disclosed is an apparatus for destroying SSD's and maintaining the physical shape of the SSD to provide tangible evidence of the destruction. The apparatus employs a crusher box having a pair of rollers with teeth in a spaced apart position constructed and arranged to penetrate an SSD. The rollers allow for the absolute destruction of the SSD and creates a distinctive pattern on the shell of the SSD. The rollers are shaped to process each SSD at a high rate of speed leaving waffle indentations that are distinctive corrugated penetrations rendering the electronic media stored in the SSD unreadable and non-accessible. The SSD outline remains the same and a majority of any identifiable markings made on the outer surface of the SSD remains legible.

An objective of the invention is to render the electronic media stored on an SSD unusable and irretrievable.

Another objective of the invention is to provide a crusher device employing counter rotating rollers having cylindrical arrays of hardened steel teeth in a spaced apart position to cause media destruction of an SSD yet rending a distinctive waffle pattern to the outer shell of the SSD allowing visual confirmation of destruction.

Still another objective of the invention is to provide adjustable cylindrical rollers to accept and destroy 1.5″ to 2.5″ SSD's without the need to remove plastic or aluminum casings, or use any special adapter.

Still another objective of the invention is to provide a device capable of rending the electronic media on an SSD unreadable and inaccessible in less than 10 seconds.

Another objective of the invention is to provide an apparatus that can destroy electronic media in SSD's at a rate of 720 per hour, which is about 1 SSD every 5 seconds.

Still another objective of the invention is to employ helically stacked sharp-profile discs (teeth) that operate at a relatively high speed to cut into SSDs producing a waffle pattern effect.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a front perspective view of the SSD high speed destroyer of the instant invention;

FIG. 2 is a top view depicting the crush box and driver;

FIG. 3 is a top plane view of the crush box;

FIG. 4 is a top plane view of the crush box with dimensions;

FIG. 5 is an end view of the crush box;

FIG. 6 is a side view of the first roller;

FIG. 7 is a side view of the second roller;

FIG. 8 is a side view of the teeth; and

FIG. 9 is an end view of the teeth;

FIG. 10 is a plane side view of an SSD;

FIG. 11 is a plane side view of a destroyed SSD; and

FIG. 12 is a rear prospective view of the SSD high speed destroyer.

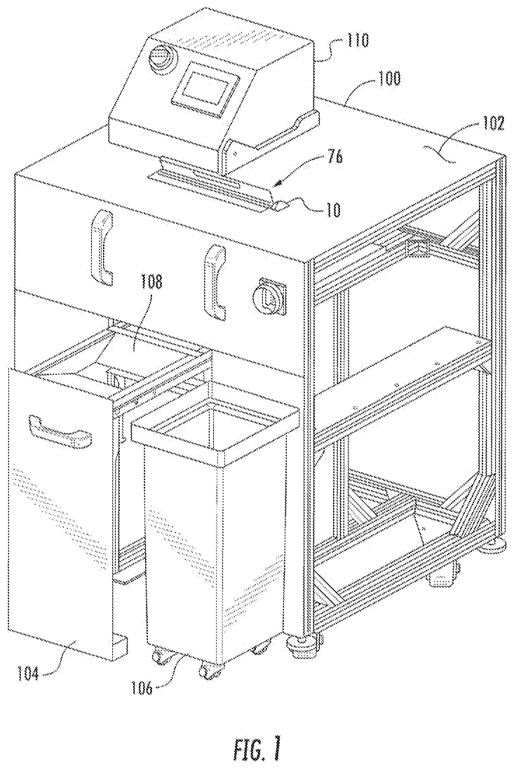

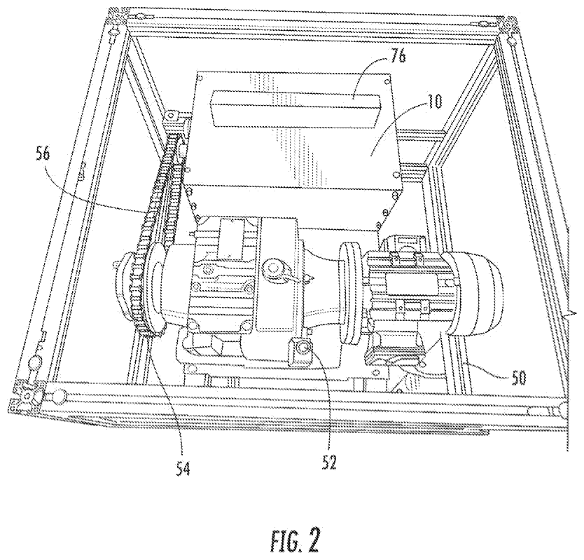

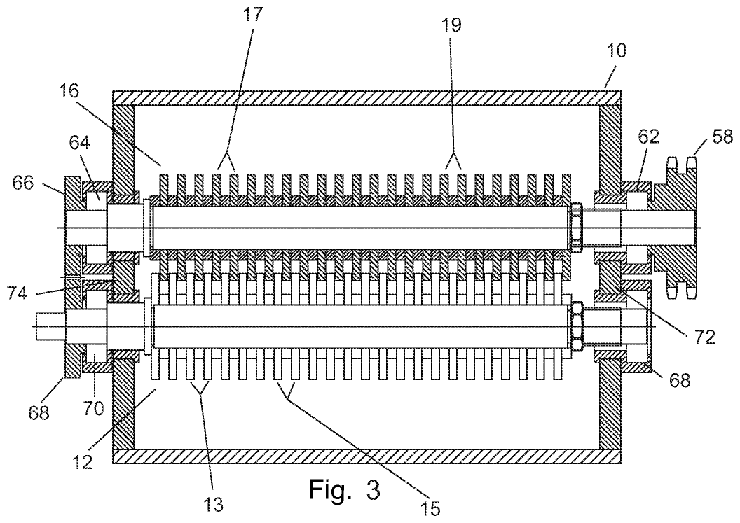

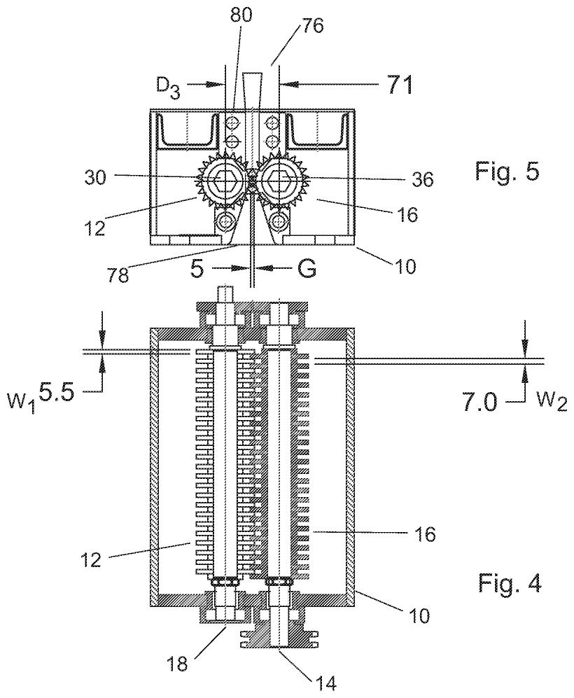

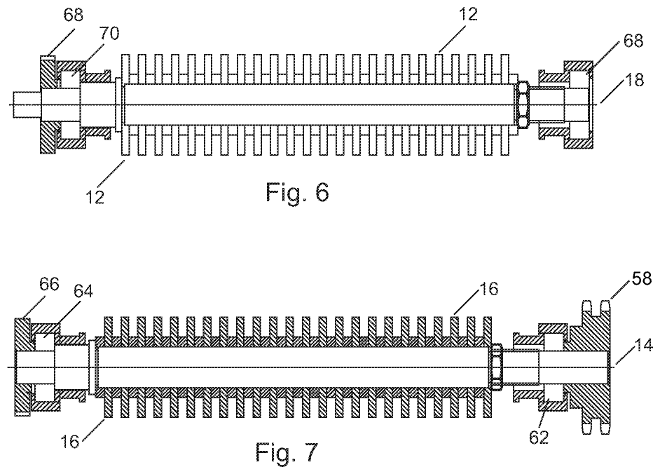

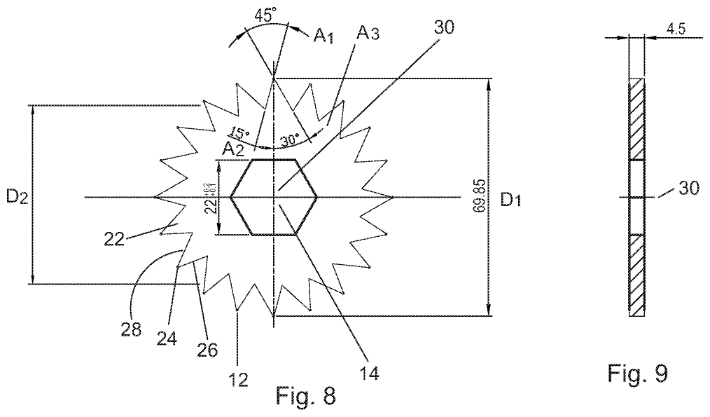

### DETAILED DESCRIPTION OF THE INVENTION

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Referring now to the Figures, set forth is an apparatus for destroying solid state drives (SSD). The apparatus employs a crushing box 10 having a first roller 12 with a first centrally disposed axle 14 spaced apart from a second roller 16 with a second centrally disposed axle 18. The first roller 12 and the second roller 16 are positioned to be counter-rotating with directional teeth. The entryway 76 to the crusher box 10 is located on an upper surface 102 of the housing. A pullout drawer 104 houses a wheel mounted receptacle 106 for use in capturing SSD's fed through the entryway 76 for destruction. An upper portion 108 of the drawer 104 is sloped to cause spent SSD's to fall within the wheel mounted receptacle 106. A control module 110 employs sensors to detect media feed jams with a controller to automatically reverse the fee to unjam the media. The control module 110 automatically powers off after 60 seconds of inactivity to conserve energy. RFI and EMI suppression minimize interference with local electronic equipment.

In a preferred embodiment the first roller 12 is defined by an outer diameter D1 of about 69.85 mm, an inner diameter D2 of about 50 mm, and a width W1 of about 5.5 mm. From the outer diameter D1 to the inner diameter D2 each tooth 22 has an insertion tip 24 with leading side surface 26 and a trailing side surface 28 formed at an angle A1 of about 45 degrees. The leading side surface 26 is formed at an angle A2 of about 15 degrees from a centrally disposed axle 30. The trailing side surface 28 is formed at an angle A3 of about 30 degrees from the centrally disposed axle 30. For drawing simplicity, each tooth of the twenty four 22 are formed of the same angles with a single tooth numbered to avoid drawing confusion. The first roller and the second roller 16 are interchangeable with the first roller 12. However, the second roller 16 is positioned in the crush box 10 in a reverse format wherein the leading side surface 26 of each tooth 22 is used to grab an SSD and pull the SSD between the rollers 12, 16 for destruction.

Each tooth on the first roller 12 having a width W1 is spaced apart from an adjoining tooth by width W2 of about 7 mm. The spacing is formed by positioning the first roller 12 centrally disposed axis 30 from the second roller 16 having a centrally disposed axis 36 by a distance D3 of about 71 mm which provides a gap G of about 5 mm between the inner diameters of each roller. The rollers 12 & 16 are constructed of high Rockwell hardness 62-64 HRc. The rollers 12 & 16 are preferably adjustable wherein the teeth are positioned to cause maximum cutting with a 61.5 mm center to center spacing having 8.3 mm penetration, as well as lesser cuttings of 63 mm having 6.8 mm penetration, 64.5 mm having 5.3 mm penetration, or 66 mm center to center having a spacing between teeth of about 3.8 mm.

The control module 110 is coupled to a variable frequency drive and proportional integral derivative (“VFD-PID”) controller 111 for rotation of the first roller 12 in a clockwise direction. The first roller 12 rotatably coupled to the second roller 16 in a counter-clockwise direction by the spur gears 66 and 68. The VFD-PID controller 111 is used to vary the speed of the electric motor 50 by changing the frequency of the electric power going to the motor. Conventional power operates at 60 hertz (Hz) and the motors operated at 900, 1,200, 1,800 rpm, or 3,600 rpm depending on how the motor is wound. In the case of the HTP-SSD, operating on single phase power connected to 4-pole, 1.1 kw motor by a single-phase in and 3-phase out VFD.

The VFD-PID controller 111 provides frequency setting and motor switching (i.e. 50 Hz, 60 Hz, Acceleration, Deceleration, Forward, Reverse, etc.). Incorporated into the VFD is a PID feedback signal that allows for various target values to be set. One of the parameters is “Over-torque Detection”. When the output current exceeds over-torque detection level and exceeds over-torque detection time, the over-torque detection will flag the system. The warning will be off only until the output current is smaller than 5% of the over-torque detection level. This “Over-torque Detection” function prevents jams and allows the user to recover from a jam if one occur wherein Torque Calculation t=9550*p/n, p is power in kw, n is rpm (1800*gear ration=170:1), t unit is NM.

t=9550*1.1/(1800/170)=992 NM

The interlacing tooth discs 30 penetrates and shears, leaving an imprint indention pattern on the SSDs. The roller assembly is made up of individually stacked discs 30 rotated every 60 degrees to create a helical pattern. The hardened discs material has a maximum yield strength to withstand ultimate stresses beyond its typical use, but in case of tooth facture, the granularity of the interlacing teeth compensates for missing tooth tips. Even much so, the rollers are interchangeable, and each disc can be replaced with minimal effort.

The first roller 12 and the second roller 16 operate jointly to pull an SSD between the teeth 22 with a distinctive waffle pattern cut into the SSD. The destroyed SSD remain intact so that they can be counted manually or otherwise verified. The SSD can be 1.8″ or 2.5″ drives using either plastic or metal cases.

The instant invention operates using identifiable geometry differences (i.e. no spring tension, cam linkages, spring pistons, etc.). The counter rotating teeth rollers are interchangeable for ease of service and provides interlacing spacing for imprint granularity (2 mm×2 mm or less). The drive mechanism operates using a gear electric motor 50, coupled to two spur gears 66 & 68, and controlled by the variable frequency drive—proportional-integral-derivative controller 111, which deforms and imprints a pattern on SSD drives at a high rate of speed using the PID constant feedback signal. (<3 seconds per 2.5-inch SSDs).

The rollers are operated by a electric motor 50 that is coupled to a gear box 52. The electric motor operates a 3600 rpm's drawing 15 amps at 100 volts or 7.5 amps at 220 volts. The gear box 52 reduces the speed providing an increase in torque for rotation of a gear 54 causing rotation of a chain 56 that is attached to a sprocket 58 of the second roller 16. The sprocket 58 provides a direct rotation of the roller which is held in position by frontal bearings 60 and rear bearing 62. The end 64 of the second roller 16 includes driver gear 66 that meshes with receipt gear 68 causing rotation of the first roller 12. The first roller having frontal bearings 68 and rear bearing 70. Forward and rearward adjustment blocks 72 and 74 provide an adjustable spacing between the first roller 12 and the second roller 16.

The crusher box 10 includes an entry 76 and exit 78. Preferably the entry 76 includes alignment pins 80 located on either side of the entry 76 to maintain an SSD placed into the entry to assure gravity will assist in aligning the SSD between the rollers 12 and 16. The angles on the frontal side surface of the teeth are positioned to assure that the teeth will grab the SSD allowing assurance that the media will be pulled into the crusher box.

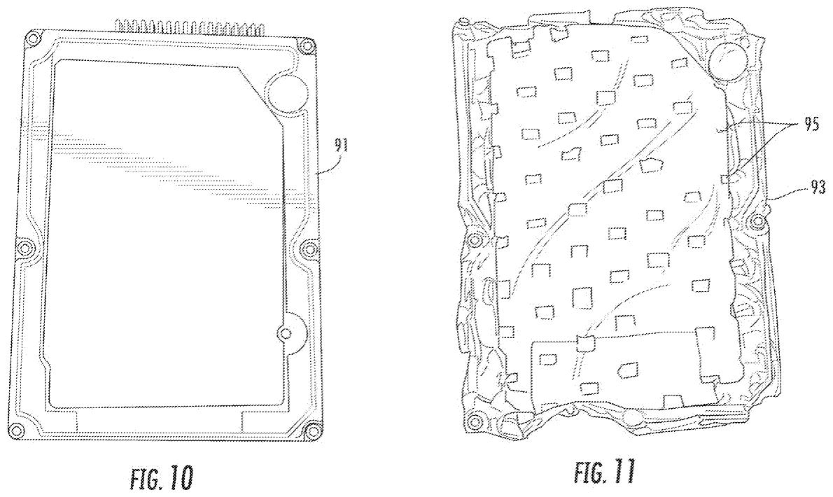

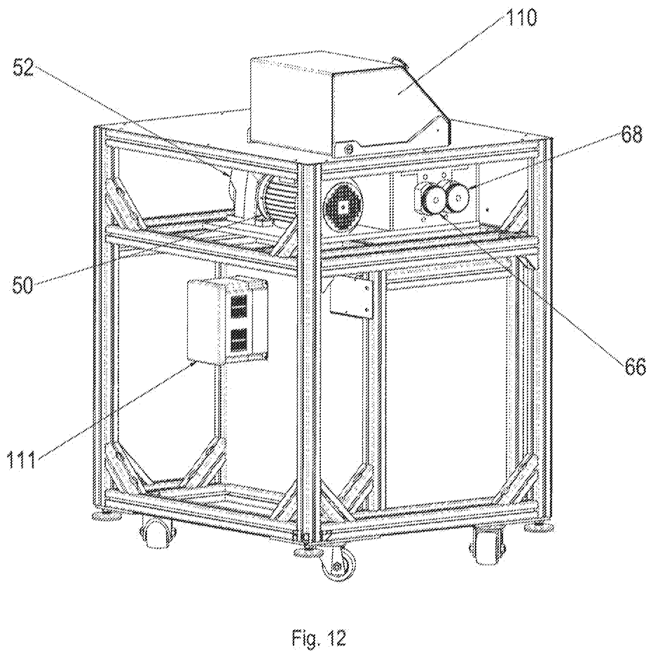

FIG. 10 illustrates an SSD 91 that may have been destroyed through conventional demagnification or still operational. Without markings on the casing, the destruction of the electronic media can only be assumed. FIG. 11 illustrates an SSD that that been drawn through the rollers of the instant invention. The casing 93 has been permanently disfigured with a pattern of penetrations 95 that is easily recognized thereby providing visual verification that the particular SSD had been rendered inoperable.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed. The term “about” means, in general, the stated value plus or minus 5%.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An apparatus for destroying a solid state drive (SSD) while maintaining SSD housing shape for identification, said apparatus comprising:
a crushing box forming an interior and an exterior with an entry into the interior and an exit from the interior;
a first roller having a first axis centrally disposed and rotatably secured to said interior of said crushing box, said first roller including rows of teeth, each row having a plurality of teeth positioned along an outer diameter (D1) of said first roller with each tooth having a 45 degree tip with a leading side edge positioned at about 15 degrees from said axis, each tooth having a width (W1) and each row having teeth spaced apart from an adjoining row forming a gap;
a second roller having a second axis centrally disposed and rotatably secured and positioned at a fixed distance which is parallel to said first roller, said second roller forming a mirror image of said first roller, said second roller having rows of teeth rotatable within said gap formed within each row of said first roller;
an adjustable block adjustably positioned between said first roller and said second roller maintaining said first and second roller in a spaced apart position to prevent shearing of the SSD;
a drive mechanism having a gear motor coupled to spur gears and controlled by a variable frequency drive—proportional integral derivative controller for controlling speed of rotation of said first roller operated in a clockwise direction and said second roller operated in a counter-clockwise direction, said control having a feedback signal to detect rotational jabs of said drive mechanism;
wherein an SSD placed between said first and second roller is drawn therebetween causing irreparable damage to said SSD and embedding a pattern on the SSD without fragmenting the SSD providing a constant feedback signal to said proportional integral derivative controller, whereby the SSD can destroyed at a rate of speed of about 3 seconds per 2.5″ SSD and be stored indefinitely with the embedded pattern having an imprint granularity of 2 mm×2 mm or less providing a distinctive waffle pattern to illustrate visual of the SSD destruction.

2. The apparatus for destroying a solid state drive (SSD) according to claim 1 wherein said outer diameter D1 of each said roller is about 69.85 mm.

3. The apparatus for a solid state drive (SSD) according to claim 1 wherein said width (W1) is about 5.5 mm.

4. The apparatus for destroying a solid state drive (SSD) according to claim 1 wherein said gap is about 7 mm.

5. The apparatus according to claim 1 for destroying a solid state drive (SSD) where a trailing side edge of each tooth on said first roller is positioned at 30 degrees from said first axis and each said tooth on said second roller is positioned at 30 degrees from said second axis.

6. The apparatus according to claim 1 for destroying a solid state drive (SSD) wherein each said row includes about 20 teeth.

7. The apparatus according to claim 1 for destroying a solid state drive (SSD) wherein each roller includes about 24 rows of teeth.

8. The apparatus according to claim 1 for destroying a solid state drive (SSD) wherein each roller includes about 24 rows of teeth.

9. The apparatus according to claim 1 for destroying the operational aspects of a solid state drive (SSD) wherein each roller and teeth are constructed of Rockwell hardness of about 60-64 HRc.

10. The apparatus for destroying a solid state drive (SSD) according to claim 1 wherein said first roller is adjustable to said second roller from the group consisting of: 61.5 mm center to center spacing having 8.3 mm penetration, or 63 mm center to center spacing having 6.8 mm penetration, or 64.5 mm center to center spacing having 5.3 mm penetration, or 66 mm center to center spacing having 3.8 mm penetration.

11. The apparatus according to claim 1 for destroying a solid state drive (SSD) said drive mechanism is constructed and arranged to destroy SSD's at a rate of 720 SSD's per hour.
